(19) United States
(12) Patent Application Publication
(10) Pub. No.: US 2001/0036425 A1
(43) Pub. Date: Nov. 1, 2001

(54) Device for transferring samples of micro-amounts of liquids

(76) Inventors: Michel Gazeau, Saint-Julien-En-Genevois (FR); Serge Lancon, Nijoux (FR)

Correspondence Address: Irving N. Feit, Esq., HOFFMANN & BARON, LLP, 6900 Jericho Turnpike, Syosset, NY, 11791, US

(21) Appl. No.: 09/817,418

(22) Filed: Mar. 26, 2001

Related U.S. Application Data
(63) Continuation-in-part of application No. 09/051,553, filed on Jun. 10, 1998, now abandoned.
Application No. 09/051,553 is a continuation-in-part of application No. PCT/FR96/01602, filed on Oct. 14, 1996.

(30) Foreign Application Priority Data
Oct. 12, 1995 (FR) 95/11996

(51) Int. Cl. B01L 3/02

(52) U.S. Cl. 422/100

(57) ABSTRACT

The present invention relates to a device for the transfer of samples of micro-quantities of liquids, of the type which has a set of aspiration/delivery nozzles (15 to 22) communicating by means of flexible tubes with one or more syringes provided with a motor-driven piston, said nozzles (15 to 22) being mobile and supported by some mechanical means allowing one to modify the spacing between two consecutive nozzles (15 to 22) continuously and with constant spacing, said mechanical means having a number of identical deformable crosspieces arranged in parallel planes, each crosspiece being formed by a set of arms articulated at their intersections for the modification of the spacing between the nozzles, the nozzles being located at least at certain nodes, the nodes being aligned in a direction perpendicular to the planes of said crosspieces in order to form an equidistant grid of nodes with variable spacing increment allowing continuous variation between a minimum spacing and a maximum spacing.

### FIELD OF THE INVENTION

The present invention concerns a device for the transfer of samples of fluids.

### BACKGROUND OF THE INVENTION

The general principle of such devices is known in the state of the art, for example, from U.S. Pat. No. 3,444,742, which describes an apparatus for the transfer of liquids between a supply tube and nozzles with variable spacing. These nozzles are supported by a vertical crosspiece.

Also known is an apparatus for filling bottles which is described in U.S. Pat. No. 662,087. This apparatus has nozzles supported by a horizontal crosspiece. The nozzles are fed from a common reservoir.

These apparatus are not suitable for the transfer of micro-quantities of liquids that satisfy the requirements of biological analysis.

In this field, it is necessary to be able to transfer micro-quantities of samples or reagents from a multi-well container, which has a grid of cavities with a given spacing, where each of said cavities contains a different type of liquid, to another holder containing a similar grid but with different spacing.

In the sense of the present patent, micro-quantities is understood to mean quantities between a fraction of a microliter and a few milliliters.

Devices of the prior art are not suitable because they are provided for transferring a single liquid from a single reservoir shared by all the nozzles to a number of receivers in which this liquid will be distributed.

Such an apparatus is known from U.S. Pat. No. 662,087.

The transposition of a known nozzle displacement mechanism for reagent bottle filling apparatus to the realization of an apparatus for microbiology can also not be envisaged because the minute displacements require great precision and perfect reproducibility. The proposed solutions with a single crosspiece are not suitable for such operations.

Also known is an apparatus which is described in European Patent No. 0280473, which pertains to a sample transfer device where only articulated mechanical means are described.

These means only enable one to go from a first spacing to a second spacing. They do not enable one to produce a continuous predetermined spacing chosen between a closed position and a separated position.

The invention aims to remedy these disadvantages by proposing an apparatus making it possible to adjust with great precision and reproducibility the spacing increment of the nozzles between any values over a very broad range.

### SUMMARY OF THE INVENTION

For this purpose, the invention consists, in its most general sense, of positioning the nozzles at the nodes of a set of at least two identical and superposed crosspieces, each of the nozzles being fed separately by a flexible pipe.

The use of several crosspieces arranged in parallel planes makes it possible to compensate for nonlinear deformations of the crosspieces and to ensure a regular and perfectly reproducible displacement of the nozzles, where the displacements are between any positions.

The invention can be realized in two different forms:

in the form of a portable apparatus operated by the user;

or in the form of a stationary apparatus.

Other refinements are optionally proposed:

in order to balance the nozzle displacement system as well as possible, a preferred variant consists of using three adjacent and superposed crosspieces, with the middle crosspiece counterbalancing the other two crosspieces, or four crosspieces, with the middle two crosspieces counterbalancing the two exterior crosspieces.

the adjustment of the travel can be ensured by a means of limiting the travel of said crosspieces;

this means of limiting the travel of said crosspieces can be associated with visual, auditory or audio cueing;

the nozzles can be driven by belts or by using two parallel racks with opposing teeth, situated on both sides of a gearwheel.

An essential characteristic of the invention is the possibility of variation of the spacing from a very close position, compatible with the micro-holders for samples, to a position separated by several centimeters. Moreover, the invention aims to propose a lightweight solution so as to avoid the routine use of bulky and expensive manipulator arms of the laboratory automated-controller type.

In a first embodiment, the device is present in the form of a tubular body which can be operated manually, and which has a set of nozzles with constant spacing at its end.

So-called manual devices make it possible to perform different operations, such as pipetting, dilution, distribution of aliquot fractions, titration, measuring unknown volumes, mixing, or else programmed sequences of the aforementioned operations.

The manipulator manually displaces this type of device and positions it over the plates or wells containing the liquids to be sampled or which are intended for receiving the liquid samples. These devices are suitable for plates or wells of which the spacing of the receptacles is compatible with that of the nozzles. In contrast, it is impossible to use this type of device for transferring micro-quantities of liquids between two supports which have receptacles with different spacing.

In the second embodiment, the device is supported by a remote-controlled manipulator. In certain variants, the remote-controller manipulator supports a number of syringes and a number of needles whose spacing can be modified. However, the space requirement of a needle holder does not allow one to reduce the spacing of the sampling ends below a certain minimum value on the order of a centimeter.

The object of the present invention is to propose a simple device, which can be manipulated manually or displaced by a robot or else can be associated with a manipulator arm which constitutes a removable accessory, allowing one to transfer a micro-quantity of liquid between a first holder which has cavities a certain distance apart, to a second holder of a different type.

To this end, the invention relates to a device in which the aspiration/delivery nozzles are connected to one or more syringes provided with a motorized or manually controlled piston, the nozzles being supported by mechanical means allowing one to modify the spacing between two consecutive nozzles. Preferably, a given syringe is connected to a single nozzle or to all of the nozzles.

This embodiment allows one rapidly and continuously to adapt the configuration of the device to different types of sample holders, and particularly to adapt the configuration during the operation of transfer between a holder with a first type of spacing of the cavities or wells and a second holder with a second type of spacing.

Preferably, the nozzles are arranged so as to form a grid with variable spacing.

According to a preferred embodiment, the mechanical means for the modification of the spacing between the nozzles consists of a deformable grid, the nozzles being arranged at least at certain nodes of the grid. The grid can be made up of equal intervals, which ensures a variable but equidistant spacing of the nozzles, or can have unequal intervals, which makes it possible to provide a non-constant spacing of the nozzles. This last embodiment is particularly suitable for filling tubes in a carrousel. In particular, this embodiment means a curved travel path of the nozzles and a distribution of the possible positions on this curve.

Advantageously, the mechanical means for the modification of the spacing between the nozzles consist of a set of arms articulated at their intersections and forming a deformable crosspiece, the nozzles being attached on said deformable crosspiece at the site of at least one part of the intersections.

According to a variant, the device has some electromechanical means for modifying the spacing between two points of the deformable grid.

According to a second variant, the device has some electromechanical means for modifying the angle formed between two arms of said deformable parallelograms.

Preferably, the device according to the invention has some electromechanical means for modifying the spacing between two points of the deformable grid.

According to a particular embodiment, the nozzles are suitable for receiving interchangeable end pieces.

The invention will be better understood upon reading of the following description referring to the appended drawings relating to a nonlimiting embodiment of the invention.

### BRIEF DESCRIPTION OF THE DRAWINGS

FIG. 1 represents a front view of the device according to the invention;

FIG. 2 represents a cross-sectional view along plane AA′ of the device in the mode of maximum spacing of the nozzles;

FIG. 3 represents a cross-sectional view along plane AA′ of the device in the mode of minimum spacing of the nozzles;

FIG. 4 represents a front view of an embodiment variant of a device according to the invention;

FIGS. 5 and 6 respectively illustrate a front view and a top view of another variant of a device according to the invention;

FIG. 7 illustrates a cross section of a mobile stop system.

### DETAILED DESCRIPTION OF THE PREFERRED EMBODIMENTS

The device according to the embodiment example described in more detail has body (1) whose dimensions are suitable for manual manipulation. This body (1) consists of a tubular element closed at its lower end by plate (2) and at its upper end by plate (3).

Plate (3) supports a set of 8 [sic] stationary syringes (4 to 7), each of which is provided with a piston (8 to 11). The pistons are actuated by motor (12) which acts simultaneously on all of the pistons by means of connecting piece (13) which is moved by an endless screw in a known manner.

The lower part of body (1) encloses support plate (14) which supports nozzles (1 5 to 22). These mobile nozzles (15 to 22) are connected to the opposite ends of stationary syringes (4 to 7) with respect to pistons (8 to 11). A syringe is connected to a nozzle by means of flexible tube (23). The needles are supported by a needle holder allowing rapid replacement. According to a variant, the needle holder allows a vertical displacement of the needle, which allows adaptation to holders of unequal height.

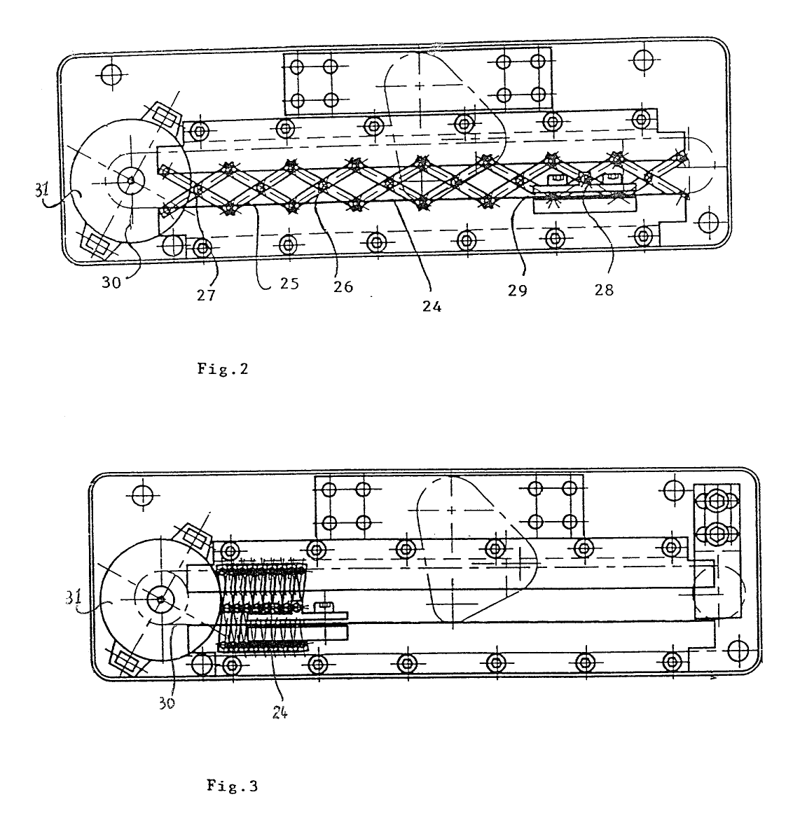

FIG. 2 is a view according to a medial section through support plate (14).

It has two articulated crosspieces (24) each formed by a set of links (25) articulated at their centers and at their ends in order to form deformable parallelograms. Nozzles (15 to 22) are arranged at the nodes of this deformable grid and pass through medial articulations (26) of links (25).

The articulated crosspieces are fixed to support plate (14) at first medial articulation (27), which constitutes a stationary point with respect to the support plate. Medial articulation (28), opposite stationary articulation (27), is connected with a mobile piece entrained by belt (29). The belt, in turn, is entrained by pulley (30) driven by stepper motor (31).

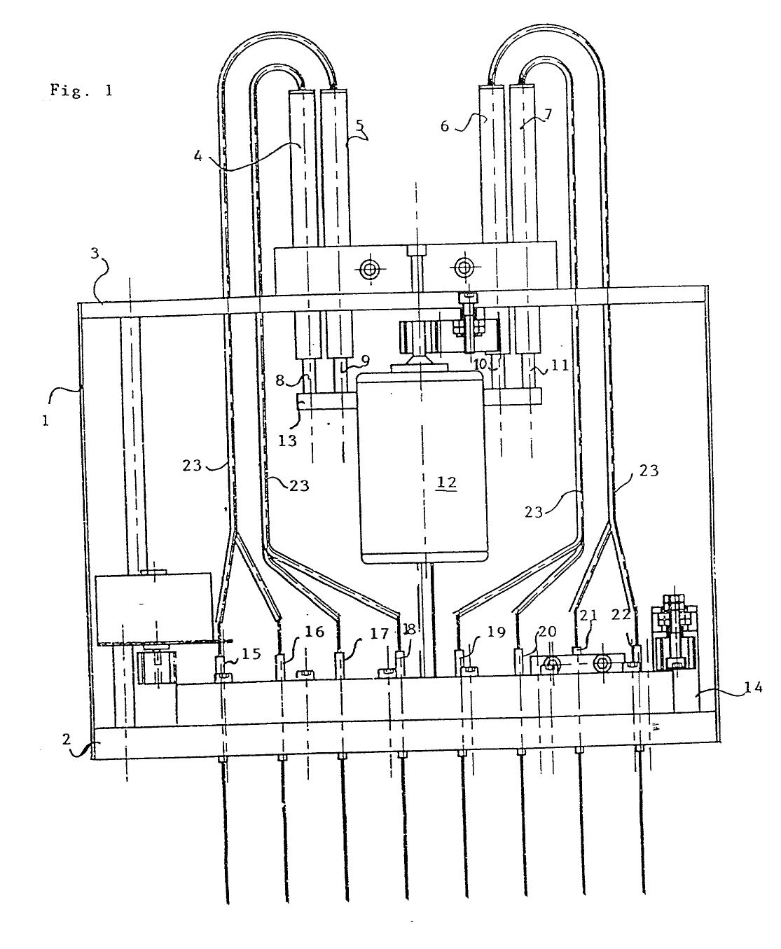

When mobile piece (28) is displaced by the belt at the end opposite stationary medial articulation (27), or as shown at the extreme right in FIG. 1, deformable crosspieces (24) are at maximum extension, so the nozzles will therefore be in the position of maximum spacing.

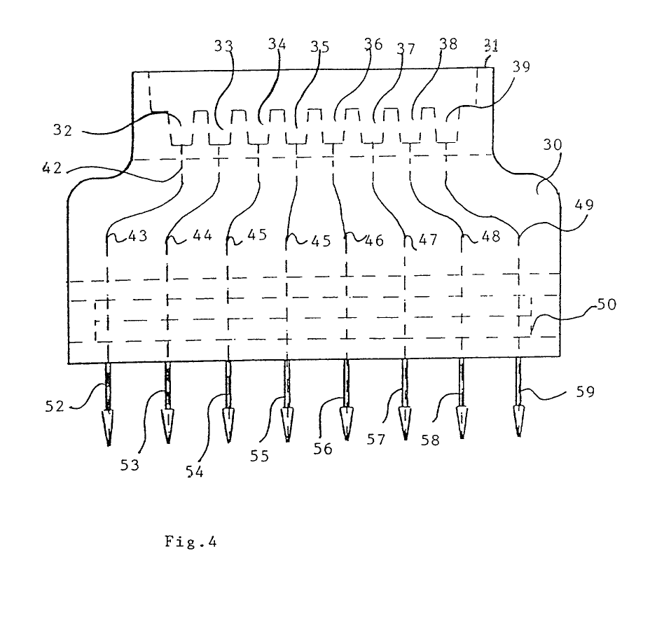

When motor (31) causes the pulley to turn in the clockwise direction, mobile piece (28) is moved in the direction of stationary medial articulation (27), which reduces the extension of deformable crosspieces (24) until a minimum extension is reached, corresponding to the situation represented in FIG. 3.

The spacing of the nozzles can thus vary progressively between a very small minimum spacing and the maximum spacing corresponding to complete extension of deformable crosspieces (24).

In a variant, the syringes can be a distance from the crosspieces.

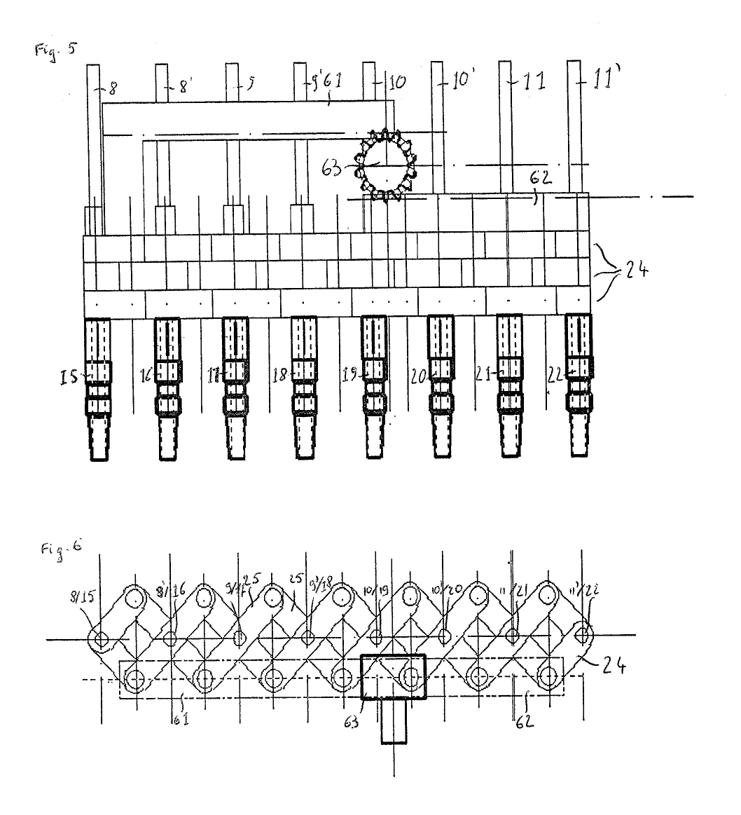

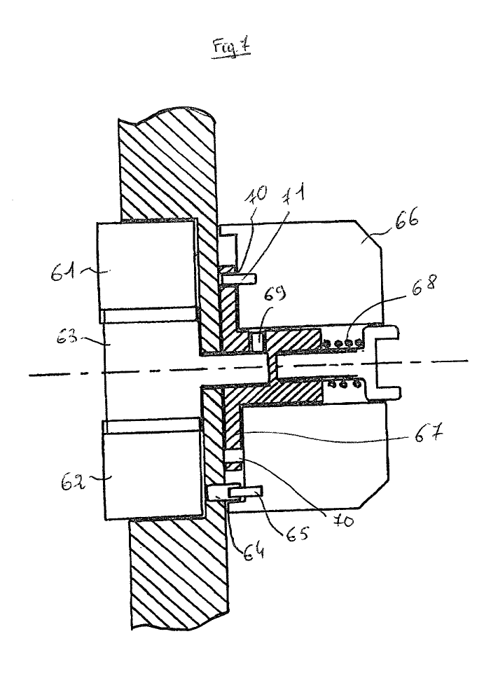

In a variant of the invention illustrated in FIGS. 5 and 6, the spacing is brought about using two parallel racks (61, 62) with opposing teeth situated on both sides of gearwheel (63). The distal ends of the racks are connected to the lateral ends of each of the crosspieces.

Thus, the two ends of the assembly of crosspieces are symmetrically separated, and the play is reduced by half.

This variant has eight needles (8, 8′, 9, 9′, 10, 10′, 11, 11′).

Each rack is secured to an end needle (8, 11′).

Gearwheel (63) is stopped either with button (66) or with a lever that pivots it manually or electromechanically by means of a micro-motor.

This button (66) or lever has a means of limiting the travel of said crosspieces. This means of limiting the travel of said crosspieces can be modified in such a way as to modify the limits of said travel.

The adjustable limits of the travel of the crosspieces allow one to find, “blind,” a maximum spacing and minimum spacing between the needles/nozzles for a given operation.

One of the ways of setting these adjustable limits is mentioned as an example with reference to FIG. 7.

The temporary maximum spacing is set by a slider/stop which is located between one of the ends, left or right, of the guide of the crosspieces and which is positioned and then locked by the operator by means of screw (69), for example.

The minimum spacing is defined by two stops (64, 65). One (64) is fixed on the body of the apparatus, for example, and the other (65) is at the periphery of the button. When the two stops are in contact, button (66) or the lever can no longer move. The angular position of the stop of the button or of the lever with respect to a reference tooth of the gearwheel is set in the following way:

The shaft of the gearwheel is connected with washer (67) which contains drilled holes (70) about its circumference and which has an axial sleeve that holds the end of the shaft. The sleeve acts as the axis of rotation for the button or lever, and it is in support on this washer by means of spring (68). It entrains washer (67) and therefore gearwheel (63) by means of pin (71) which penetrates one of holes (70) of the washer. Pulling button (66) or the lever to move it away from gearwheel (63) compresses spring (68) and disengages pin (71) from hole (70) of washer (67). The button can then turn without moving the gearwheel, so that in releasing the button, the pin enters another hole in the periphery of the washer. Specifically, this operation is performed when the nozzles are at the desired spacing. The chosen hole is that which allows one to have the two stops (one attached to the housing and one to the button) in contact.

Other methods allow one to mark one or more fixed intermediate spacings. For example, a ball can be inserted near the perimeter of the washer. It presses against the housing of the apparatus and the underside of the button. One or more recesses are formed on the surface of the housing in the path of travel of the ball. Its passage over one or another of the recesses is sensed by the operator.

The expert in the field can conceive of other methods for providing the operator with visual cues (calibration marks), audible or tactile cues, allowing the operator to identify a given spacing between the nozzles.

The needles/nozzles are displaced symmetrically with respect to their center of gravity. Differences in spacing are thus minimized.

Mechanical or electromechanical stops can allow one to limit the positions/spacings or to store them in memory.

This variant has three levels of crosspieces (24), in order to reduce the play at the articulations, while allowing a minimum width to be maintained and the rigidity of the grid to be increased.

Grooves are furthermore provided in the body of the apparatus in order to facilitate the guiding of the grid.

The needles and the nozzles are parallaxes [sic; parallel] and form the axes at the intersection of links (25) of crosspieces (24).

At their bottom ends, nozzles (15 to 22) can have possibly conical connecting pieces, threading, or necking.

The needles can be displaced vertically and have a spring-loaded home position in order to make it possible to make up for the differences in level of the cells with respect to the tubes.

The crosspieces form a sort of sandwich and are preferably produced from a metal alloy. They can by produced from an aluminum alloy, a copper alloy such as brass, or steel, for example.

Preferably, two adjacent crosspieces are not produced from the same alloy in order to prevent the occurrence of a sticking due friction between one crosspiece and another.

For example, if one crosspiece is made of aluminum, that or those adjacent to it may be made of brass or steel.

The invention is described as a nonlimiting example. It is understood that the expert in the field will be capable of producing different variants without exceeding the scope of the invention. In particular, this device can be moved by a remote-controlled manipulator in the horizontal and the vertical planes. It is also possible, without exceeding the scope of the invention, for the device to be formed in two separate blocks connected by catheter tubes. The first block contains the syringes and the electromechanical control means for the pistons of the syringes. The second block only contains the nozzle support and nozzles, and possibly the drive motor. The nozzles are connected to the syringes by means of catheter tubes joined to form a connecting bundle between the two blocks. One or more valves can also be provided between the syringes and the nozzles.

FIG. 4 represents a front view of an embodiment variant of the apparatus according to the invention.

This variant consists of an adaptor device capable of lengthening a sample manipulator with fixed spacing.

It is formed by body (30) which has on its upper surface (31) a slit which communicates with a set of connectors (32 to 39) complementary in form to the exterior shape of the end pieces of a conventional device. The connectors (32 to 39) can be formed in a block of plastic material having cylindrical housings provided with O-ring seals. They are extended by flexible tubes (42 to 49). These tubes are connected to mobile end pieces (52 to 59). The end pieces are supported by articulated structure (50) allowing continuous displacement while maintaining constant spacing between the mobile end pieces.

Such an adaptor can also be produced in nonmotorized form. In this case, a slider attached to one of the end pieces allows adjustment of the spacing, the other end piece being locked at a predetermined position by the user. Possibly, two adjustable stops allow one to limit the travel of the end pieces between a minimum and maximum spacing .

In a gel loader configuration, it is a matter of handling volumes on the order of a μL with great precision.

In this configuration, the syringes are connected to the nozzles and moved at the same time. Each piston, if necessary, can be rigidified by a sleeve fitted over the syringe, which is moved at the same time. They are actuated in concert by a smooth piece which is guided in such a way that it can be moved parallel to the direction of the syringes, in planes strictly perpendicular thereto. The rods of the pistons slide on this piece.

The syringes are mentioned as an example. Other aspiration/delivery systems can be connected to the nozzles. Manual or peristaltic pumps or any other device capable of creating increased or decreased pressure in the nozzles, such as enclosures with controlled pressure connected to the nozzles via valves, can be used.

The syringes may also be connected to the needles and moved with them. The piston of each syringe slides under a support piece which allows them to be maneuvered in concert.

What is claimed is:

1. A device for the transfer of samples of micro-quantities of liquids, of the type which has a set of aspiration/delivery nozzles (15 to 22) communicating by means of flexible tubes with one or more syringes provided with a motor-driven piston, said nozzles (15 to 22) being mobile and supported by some mechanical means allowing one to modify the spacing between two consecutive nozzles (15 to 22) continuously and with constant spacing, said mechanical means having a number of identical deformable crosspieces arranged in parallel planes, each crosspiece being formed by a set of arms articulated at their intersections for the modification of the spacing between the nozzles, the nozzles being positioned at least at certain nodes, the nodes being aligned according to a direction perpendicular to the planes of said crosspieces in order to form an equidistant grid of nodes with variable spacing allowing continuous variation between a minimum spacing and maximum spacing.

2. A device for the transfer of samples of micro-quantities of liquids according to claim 1 which has two superposed and adjacent crosspieces.

3. A device for the transfer of samples of micro-quantities of liquids according to claim 1 which has three superposed and adjacent crosspieces.

4. A device for the transfer of samples of micro-quantities of liquids according to claim 1 which has four superposed and adjacent crosspieces.

5. A device for the transfer of samples of micro-quantities of liquids according to claim 1 in which the crosspieces are arranged in a plane perpendicular to the axis of the nozzles.

6. A device for the transfer of samples of micro-quantities of liquids according to claim 1 in which the crosspieces are arranged in a plane parallel to the axis of the nozzles.

7. A device for the transfer of samples of micro-quantities of liquids according to claim 1 which has a means of limiting the travel of said crosspieces.

8. A device for the transfer of samples of micro-quantities of liquids according to claim 7 in which the means of limiting the travel of said crosspieces can be modified in such a way as to allow the limits of said travel to be modified.

9. A device for the transfer of samples of micro-quantities of liquids according to claim 7 in which the means of limiting the travel of said crosspieces is associated with a visual, audible or audio indicators.

10. A device for the transfer of samples of micro-quantities of liquids according to claim 1 in which the nozzles are suitable for receiving interchangeable end pieces.

11. A device for the transfer of samples of micro-quantities of liquids according to Claim 1 in which the needles can receive interchangeable endpiece holders allowing the use of interchangeable end pieces of different volume and shape on the same instrument.

12. A device for the transfer of samples of micro-quantities of liquids according to claim 1 in which the spacing is brought about by means of two parallel racks (61, 62) with opposing teeth, located on either side of gearwheel (63).

13. A device for the transfer of samples of micro-quantities of liquids according to claim 1 in which the needles have longitudinal displacement and a spring-loaded home position.

14. A device for the transfer of samples of micro-quantities of liquids according to claim 1 in which two adjacent crosspieces are made from the same alloy.

15. A device for the transfer of samples of micro-quantities of liquids according to claim 1 formed by body (30) which has a set of connectors (32 to 39) for receiving end pieces of a conventional device, these connectors (32 to 39) being extended by flexible tubes (42 to 49) connected to mobile end pieces (52 to 59) supported by articulated structure (50) allowing continuous displacement and maintaining a regular spacing between the mobile end pieces.

16. A device for the transfer of samples of micro-quantities of liquids according to claim 15 which has two superposed and adjacent crosspieces.

17. A device for the transfer of samples of micro-quantities of liquids according to claim 15 which has three superposed and adjacent crosspieces.

18. A device for the transfer of samples of micro-quantities of liquids according to claim 15 which has four superposed and adjacent crosspieces.

19. A device for the transfer of samples of micro-quantities of liquids according to claim 15 in which the crosspieces are arranged in a plane perpendicular to the axis of the nozzles.

20. A device for the transfer of samples of micro-quantities of liquids according to claim 15 in which the crosspieces are arranged in a plane parallel to the axis of the nozzles.

21. A device for the transfer of samples of micro-quantities of liquids according to claim 15 which has a means of limiting the travel of said crosspieces.

22. A device for the transfer of samples of micro-quantities of liquids according to claim 21 in which the means of limiting the travel of said crosspieces can be modified in such a way as to allow the limits of said travel to be modified.

23. A device for the transfer of samples of micro-quantities of liquids according to claim 22 in which the means of limiting the travel of said crosspieces is associated with a visual, audible or audio indicators.

24. A device for the transfer of samples of micro-quantities of liquids according to claim 15 in which the nozzles are suitable for receiving interchangeable end pieces.

25. A device for the transfer of samples of micro-quantities of liquids according to claim 15 in which the needles are capable of receiving interchangeable endpiece holders allowing the use of interchangeable end pieces of different volume and shape on the same instrument.

26. A device for the transfer of samples of micro-quantities of liquids according to claim 15 in which the spacing is brought about by means of two parallel racks (61, 62) with opposing teeth, located on either side of a gearwheel (63).

27. A device for the transfer of samples of micro-quantities of liquids according to claim 15 in which the needles can be displaced longitudinally and have a spring-loaded home position.

28. A device for the transfer of samples of micro-quantities of liquids according to claim 15 in which two adjacent crosspieces are not made from the same alloy.
